(19) United States
(12) Patent Application Publication
(10) Pub. No.: US 2010/0163388 A1
(43) Pub. Date: Jul. 1, 2010

(54) KEY SHEET AND KEY UNIT HAVING THE SAME

(75) Inventor: Takashi YASUHARA, Ibaraki (JP)

Correspondence Address: WESTMAN CHAMPLIN & KELLY, P.A., SUITE 1400, 900 SECOND AVENUE SOUTH, MINNEAPOLIS, MN, 55402, US

(73) Assignee: SUNARROW LIMITED, Tokyo (JP)

(21) Appl. No.: 12/596,672

(22) PCT Filed: May 8, 2008
(86) PCT No.: PCT/JP2008/058519

§ 371 Date: Oct. 20, 2009

(30) Foreign Application Priority Data
May 9, 2007 (JP) 2007-124183

(51) Int. Cl. H01H 1/10

(52) U.S. Cl. 200/5 A; 200/512

(57) ABSTRACT

Regarding a key sheet having a plurality of key tops provided at a key base made of a transparent or translucent resin, and a key unit using the key sheet, in order to make the key sheet thinner and thereby make a device using the key sheet, e.g., a cellular phone, thinner, the key sheet comprises a key base made of a transparent or translucent resin; a plurality of key tops provided on said key base; and pressing elements or a pressing element sheet having pressing elements provided at a bottom surface thereof, provided at a bottom surface of said key base, wherein said key base is molded, into a sheet form, of a thermoplastic resin which is solid at a room temperature and obtains adhesive force only in a physical change of hot melting and cooling solidification.

### TECHNICAL FIELD

The present invention relates to an illumination type key sheet for electronic devices, such as a cellular phone, a PHS (Personal Handyphone System), a portable information terminal (PDA (Personal Data Assistance) or the like), portable audio unit, and remote controller for electric home appliances, and a key unit having such a key sheet.

### BACKGROUND ART

Many key sheets for electronic devices, such as a cellular phone, a PHS, a portable information terminal (PDA or the like), a portable audio unit, and a remote controller for electric home appliances are equipped with predetermined illumination light emitting means (e.g., light emitting diode) to illuminate key tops. There is the advantage that it is easy to view the key displays, thereby facilitating the key operation, even when it is used in the dark.

The present applicant has made various proposals on such an illumination type key sheet or a key unit having such a key sheet mounted on a wiring board or the like as disclosed in, for example, Japanese Patent Application Laid-Open No. 2006-013232. FIG. 10 is a cross-sectional view showing a conventional example of a key unit having such a key sheet disposed on a wiring board.

In FIG. 10, a wiring board “a” has, for example, a multilayer wiring structure, and metal domes “b, b . . . ” constituting switching elements provided in correspondence to respective key tops to be discussed later, a light emitting diode (LED) “c” and a wiring layer connected to those components are formed on the topmost surface of the wiring board “a”.

A pressing element sheet “d” is made of, for example, silicone resin, and has pressing elements “e, e, . . . ” corresponding to the metal domes “b” and key sheet supports “f, f, . . . ”, formed at its bottom side. The key sheet supports “f, f, . . . ” are adhered to the top surface of the wiring board “a” at their bottom surfaces.

A key base “h” is made of, for example, an urethane resin and is adhered to the top surface of the pressing element sheet “d” via an adhesive layer “i” of a double-sided tape type. Key tops “k, k, . . . ” are adhered to the top surface of the key base “h” via a hot melt type adhesive layer “j”.

A cover “l” is adhered to the key base “h” via the adhesive layer “j” at its bottom surface.

[Patent Document 1] Japanese Patent Application Laid-Open No. 2006-013232

In the conventional key sheet as shown in FIG. 10, the key tops need to be adhered to the top surface of the key base via an adhesive layer, and the pressing element sheet needs to be adhered to the bottom surface of the key base via an adhesive layer, thereby causing a problem that it is difficult to make the key sheet thinner.

That is, there is a demand for making electronic devices such as a cellular phone thinner, and it is preferable to make the key sheet thinner to meet such a demand. However, the adhesive layers to adhere the key tops and pressing element sheet to the top and bottom surfaces of the key base has a certain thickness, which prevents the key sheet from becoming thinner in the conventional key sheet.

Therefore, it cannot be overlooked because it causes preventing the demand for making an electronic device such as a cellular phone thinner.

### DISCLOSURE OF THE INVENTION

The present invention addresses the above-identified problems, and an object of the present invention is to provide a thinner key sheet having a plurality of key tops provided at a key base made of a transparent or translucent resin, and a key unit using the key sheet.

In order to achieve the object, according to one aspect of the invention, there is provided a key sheet comprising a key base made of a transparent or translucent resin; a plurality of key tops provided on said key base; and pressing elements or a pressing element sheet having pressing elements provided at a bottom side thereof, provided at a bottom surface of said key base, wherein said key base is molded, into a sheet form, of a thermoplastic resin which is solid at a room temperature and obtains adhesive force only in a physical change of hot melting and cooling solidification.

According to another aspect of the invention, there is provided a key unit comprising at least: the above-mentioned key sheet; a wiring board on which said key sheet is to be mounted; switching elements which are disposed at positions corresponding to the respective key tops of said key sheet and are switched by operating said key tops on said key base; and an illumination light source, whereby light emitted from said illumination light source illuminates said key tops.

### BRIEF DESCRIPTION OF THE DRAWINGS

FIG. 1 is a cross-sectional view of a first embodiment of the present invention;

FIG. 2 is a perspective view of the first embodiment;

FIG. 3 is an exploded perspective view of the first embodiment;

FIG. 4 is a cross-sectional view of a second embodiment of the invention;

FIG. 5 is a cross-sectional view of a third embodiment of the invention;

FIG. 6 is a cross-sectional view of a fourth embodiment of the invention;

FIG. 7 is a perspective view of the fourth embodiment;

FIG. 8 is an exploded perspective view of the fourth embodiment;

FIG. 9 (A) is a cross-sectional view showing a fifth embodiment of the invention as adapted to a narrowed-pitch type key unit; and (B) is a cross-sectional view showing a modification of the fifth embodiment; and

FIG. 10 is a cross-sectional view showing a conventional example for explaining the related art.

### DETAILED DESCRIPTION OF THE INVENTION

### General Description

One embodiment of a key sheet according to the present invention is a key sheet comprising: a key base made of a transparent or translucent resin; a plurality of key tops provided on the key base; and pressing elements or a pressing element sheet having pressing elements provided at a bottom side thereof, provided at a bottom surface of the key base, wherein the key base is molded, into a sheet form, of a thermoplastic resin which is solid at a room temperature and obtains adhesive force only in a physical change of hot melting and cooling solidification.

In the present specification, provision of a plurality of key tops includes a case where a plurality of key tops are integrally formed into a single transparent or translucent sheet-like (plate-like) member.

According to the embodiment, the key base is made of a thermoplastic resin which is solid at a room temperature and obtains adhesive force only in a physical change of hot melting and cooling solidification, so that the key base itself can serve as an adhesive to adhere the key tops, pressing elements and pressing element sheet to the top and bottom surfaces of the key base. This eliminates the need for special provision of adhesive layers for adhesion of the pressing elements and pressing element sheet.

It is therefore possible to make the key sheet thinner by the thicknesses of the adhesive layers for adhesion of the pressing elements and pressing element sheet, and then make a key unit using the key sheet thinner.

According to another embodiment of the key sheet of the present invention, the thermoplastic resin of which the key base is formed is a polyester, acrylic, polyolefin, polyurethane or polyamide hot melt material.

According to the embodiment, since the thermoplastic resin of which the key base is formed is a polyester, acrylic, polyolefin, polyurethane or polyamide hot melt material, the key base itself can serve as an adhesive layer to adhere the key tops, pressing elements and pressing element sheet to the top and bottom surfaces of the key base.

According to a further embodiment of the key sheet of the present invention, a melting temperature of the key base is equal to or higher than 100° C.

According to the embodiment, since the melting temperature of the key base is 100° C. or higher, the key base integrated with the key tops, pressing elements and pressing element sheet can be formed at a temperature of 100° C. or higher. After the formation, the key sheet can retain a sufficient strength unless the temperature exceeds 100° C., so that deterioration, strength reduction, breakage or the like of the key sheet are unlikely to occur.

One embodiment of a key unit according to the invention is a key unit including at least the above-mentioned key sheet, a wiring board on which the key sheet is to be mounted, switching elements which are disposed at positions corresponding to the respective key tops of the key sheet and are switched by operating the key tops on the key base, and an illumination light source, whereby light emitted from the illumination light source illuminates the key tops.

According to the embodiment, the key unit uses the foregoing key sheet, so that the key unit can have the advantage of the key sheet.

### Description of Illustrated Embodiments

Embodiments of a key sheet according to the present invention and a key unit using such a key sheet will be described in detail below referring to the accompanying drawings.

The key sheet according to the invention and the key unit using the same are basically configured by molding a thermoplastic resin into a sheet form. The thermoplastic resin is solid at a room temperature and obtains adhesive force only in a physical change of hot melting and cooling solidification. In general, the environmental temperatures of electronic devices, such as a cellular phone, which use a key unit do not exceed 100° C., and the environmental test (heat test) of the key sheet itself is conducted at 100° C. or below. It is therefore preferable to set the allowable limit of temperature to 100° C.

It is therefore suitable that a polyester, acrylic, polyolefin, polyurethane or polyamide hot melt material, e.g., ethylene-vinyl acetate copolymer (EVA), polyamide, nylon copolymer, polyester or the like, is the essential composition of the key base.

The present invention can be adapted to a key sheet having a plurality of independent pressing elements directly provided at the bottom surface of the key base, or can be adapted to a key sheet in which a pressing element sheet having a plurality of pressing elements integrally formed at the bottom side of the a single sheet-like member are securely adhered to the bottom surface of the key base.

The present invention can be adapted to a narrowed-pitch key sheet and a narrowed-pitch key unit which have narrow pitches between adjacent key tops, as well as a key sheet and a key unit in which a part of a body (case) of a cellular phone or the like, or a cover body (top cover) separate from the case exists between adjacent key tops. While the invention has a wider range of application, such as adaptation to a key sheet or key unit having a plurality of key tops integrally formed on a single plate-like member (the key sheet being so-called “sheet keys”), only some parts of the adaptation are illustrated as embodiments herein.

### Embodiment 1

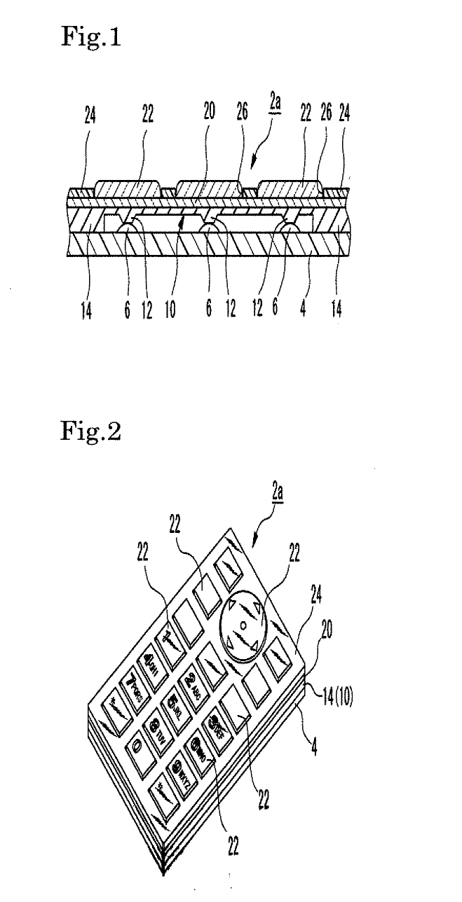

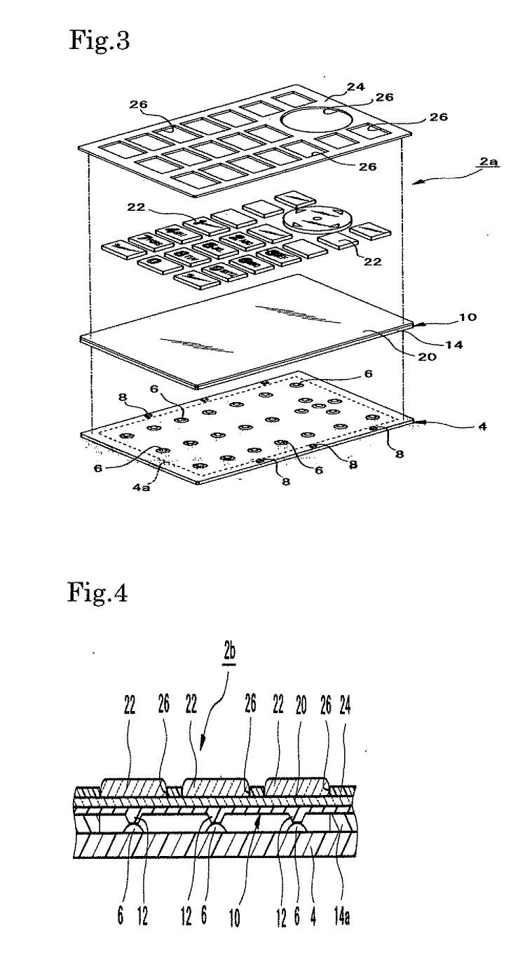

FIGS. 1 to 3 show a first embodiment (embodiment 1) 2a of the present invention. FIG. 1 is a cross-sectional view, FIG. 2 is a perspective view, and FIG. 3 is an exploded perspective view. According to the embodiment, the present invention is adapted to a key unit to be used in, for example, a cellular phone.

A wiring board 4 is incorporated in a cellular phone, for example, and has a wiring layer (not shown), metal domes 6, 6, . . . and LEDs (Light Emitting Diodes) 8, 8, . . . serving as illumination light sources, provided on the top surface thereof. While the LEDs 8 are provided on the top surface of the wiring board in the embodiment, which is not essential, the LEDs 8 may be attached to the bottom surface of a case (cover (24)) to be described later.

The metal domes 6, 6, . . . are constructed by a very thin stainless member formed into the shape of a dome. When the metal domes 6, 6, . . . are depressed from above by pressing elements (12, 12, . . . ) to be described later, contacts on the wiring board 4 (not shown) are electrically connected. A dome sheet which holds the metal domes 6, 6, . . . is provided on the top surface of the wiring board 4, is not shown in FIG. 1, and is shown by a broken line and indicated by reference numeral “4a” in FIG. 3.

A pressing element sheet 10 is formed of, for example, a silicone resin, and has the pressing elements 12 which presses the metal domes 6, 6, . . . and key sheet supports 14, 14, . . . formed on the bottom side thereof. The key sheet supports 14, 14, . . . are adhered at their bottom surfaces to the top surface of the wiring board 4. The key sheet supports 14, 14, . . . have LED receiving recesses (not shown) at the bottom surfaces where the LEDs 8, 8, . . . are contained.

A key base 20 is formed of a thermoplastic resin, specifically, a polyester, acrylic, polyolefin, polyurethane or polyamide hot melt material which melts at a temperature of 100° C. or higher and obtains adhesive force only in a physical change of the hot melting to a subsequent stage of cooling solidification. The key base 20 is adhered to the top surface of the pressing element sheet 10 (the key base itself serving as an adhesive) to be formed integrally therewith. The thickness of the key base 20 is 0.5 to 0.3 mm, for example, 0.2 mm.

The hot melt material need not be perfectly transparent, but needs to have a light transmissive (translucent) property.

Key tops 22, 22, . . . are made of a transparent or translucent resin, such as polycarbonate. The key tops 22, 22, . . . are adhered to the top surface of the key base 20 made of a hot melt material by the adhesive force of the key base 20 itself.

A top cover 24 has a decorative role and a structural role of adding a shape stability to the key sheet. As is the case with the key tops 22, 22, . . . , the top cover 24 is adhered to the top surface of the key base 20 made of a hot melt material. The key tops 22, 22, . . . are loosely inserted into key-top insertion holes 26, 26, . . . .

According to the embodiment 2a as shown in FIGS. 1 to 3, only a part of the key base 20 or only the portion which works for adhesion of other materials melts at a temperature of 100° C. or higher for pressure bonding of other materials to the portion. That is, the key base 20 itself can serve as an adhesive to adhere the key tops 22, 22, . . . and the pressing element sheet 10 to the top and bottom surfaces of the key base 20 because key base 20 is formed of a sheet-like hot melt material serving as an adhesive layer for, for example, a silicone resin to be the material for the pressing element sheet 10 and a polycarbonate resin or the like to be the material for the key tops 22, 22, . . . .

Therefore, it is unnecessary to specially provide an adhesive layer for adhering the key tops and pressing element sheet. It is therefore possible to make the key sheet thinner by the thicknesses of the adhesive layers for adhering the pressing elements and pressing element sheet, and then make a key unit using the key sheet thinner.

The key sheet according to the embodiment 1 can be fabricated by the following method.

At first, a hot melt material is formed into a sheet form to be the key base 20, and a plurality of key tops 22, 22, . . . are arranged beforehand on a jig previously prepared where a plurality of key tops can be disposed, bottom surface up, at a preset positional relationship.

Then, the key base 20 formed of the sheet-like hot melt material is positioned on the key tops 22, 22, . . . , and the pressing element sheet 10 is positioned on the key base 20 to be aligned bottom surface up. On this condition, they are heated (at a heating temperature adequately higher than 100° C.) and the key base 20, the key tops 22, 22, . . . and the pressing element sheet 10 are pressed, adhered and integrated together so that the key base 20 formed of the hot melt material of the thermoplastic resin itself serves as an adhesive.

### Embodiment 2

FIG. 4 shows a second embodiment (embodiment 2) 2b of the present invention.

Though the embodiment 2b differs from the key unit 2a as shown in FIGS. 1 to 3 only in that key sheet supports (spacers) 14a, 14a, . . . are formed of a resin separate from that of the pressing element sheet 10, the other points are common. Therefore, same reference numerals are given to the common portions while different reference numerals are given to the different portions. A perspective view and exploded perspective view are omitted because they differ from FIGS. 2 and 3 only in that the reference numeral to the key sheet supports is “14a” instead of “14”, and the pressing element sheet 10 appears as a member separate from the key sheet support 14a in the drawings.

As is apparent from the above, the present invention can be adapted to a case where the key sheet supports 14a, 14a, . . . are formed of a resin separate from that of the pressing element sheet 10, and it can have the same effects as the first embodiment as shown in FIGS. 1 to 3.

### Embodiment 3

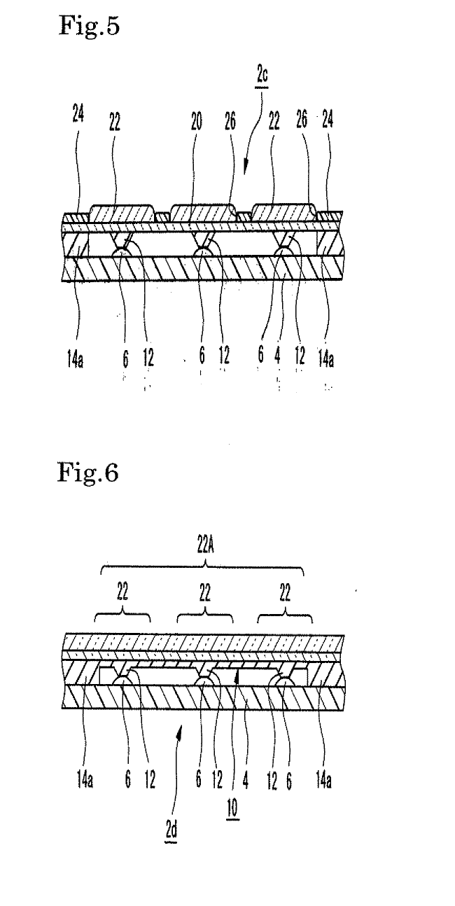

FIG. 5 shows a third embodiment (embodiment 3) 2c of the present invention.

Though the embodiment 2c differs from the key unit 2a as shown in FIGS. 1 to 3 only in that there is no pressing element sheet 10, and pressing elements 12, 12, . . . and separate key sheet supports (spacers) 14a, 14a, . . . are formed on the bottom surface of the key base 20, the other portions are common. Therefore, same reference numerals are given to the common portions while different reference numerals are given to the different portions. A perspective view and exploded perspective view are omitted because they differ from FIGS. 2 and 3 merely in that the reference numeral to the key sheet supports is “14a” instead of “14”, and the pressing element sheet 10 does not exist and therefore does not appear in the drawings.

As is apparent from the above, the present invention can be adapted to a case where there is no pressing element sheet 10, and the pressing elements 12, 12, . . . and key sheet supports 14a, 14a, . . . are directly adhered to the key base 20, and it can have the same effects as the first embodiment as shown in FIGS. 1 to 3 and the second embodiment as shown in FIG. 4.

### Embodiment 4

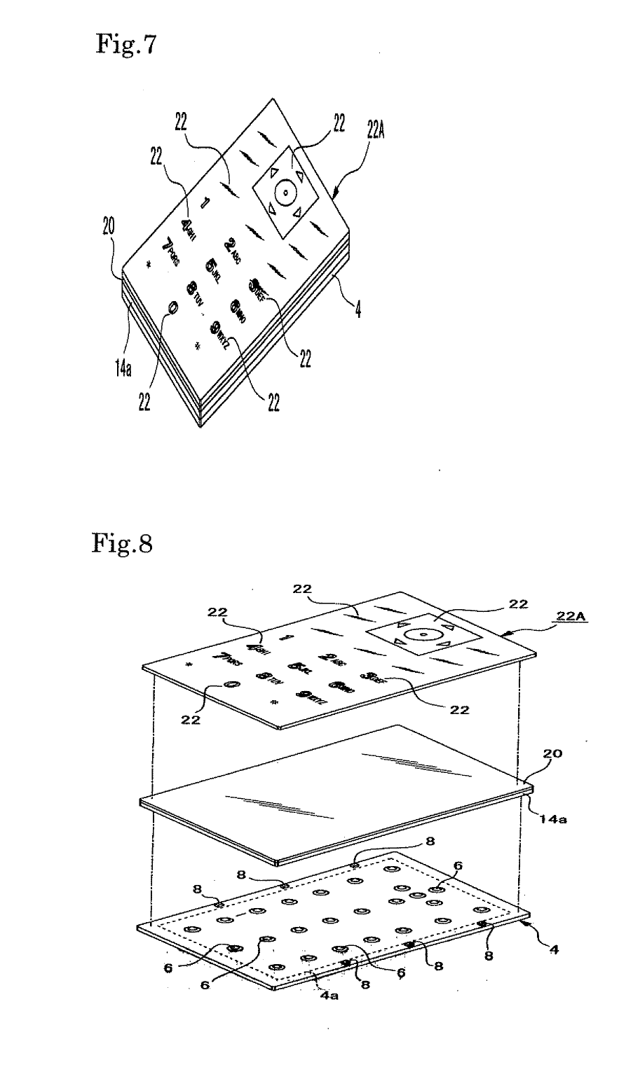

FIGS. 6 to 8 show a fourth embodiment (embodiment 4) 2d of the present invention. FIG. 6 is a cross-sectional view, FIG. 7 is a perspective view, and FIG. 8 is an exploded perspective view. According to the embodiment 2d, the present invention is adapted to a sheet type key unit in which key tops 22, 22, . . . are integrally formed into a key top aggregate plate 22A made of a transparent or translucent resin.

The descriptions of the structures of the wiring board 4, pressing element sheet 10 and key base 20 is omitted because they have the same structures as those of the first embodiment 1a.

Article number 22A shows a key top aggregate plate of a transparent or translucent resin, or an adequate metal plate into which all the key tops 22, 22, . . . of the key unit 2d are integrally formed, and adhered onto the above-mentioned key base 20.

The key base 20 is integrally adhered to the pressing element sheet 10 and the key top aggregate plate 22A by the key base 20 itself serving as an adhesive as is the case with the first embodiment 1a.

Therefore, the effects of the embodiment 2d are the same as those of the first embodiment 1a.

As apparent from the above, the present invention can be adapted to various kinds of key sheets and key units with the same effects as mentioned above.

### Embodiment 5

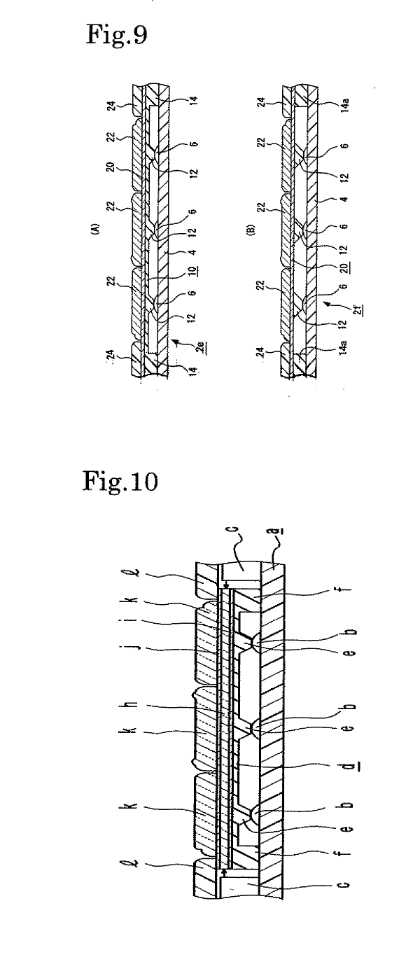

FIG. 9(A) is a cross-sectional view showing a fifth embodiment (embodiment 5) 2e of the present invention, and FIG. 9(B) is a cross-sectional view showing a modification 2f of the fifth embodiment.

The key units 2e, 2f shown in FIGS. 9(A) and 9(B) are applications of the present invention to a narrowed-pith type key unit where a part of the body (case) of a cellular phone or the like does not exist between adjacent key tops, and have no other differences from the first embodiment 2a shown in FIGS. 1 to 3.

The key unit (modification) 2f shown in FIG. 9(B) differs from the key unit 2e shown in FIG. 9(A) only in that the pressing elements 12, 12, . . . and the key sheet supports 14, 14, . . . are directly attached to the key base 20 without using a pressing element sheet, and has no other differences form FIG. 9(A).

As apparent from the above, the present invention can also be adapted to a key sheet and key unit of a narrowed-pitch type.

### INDUSTRIAL APPLICABILITY

The present invention can be applied to an illumination type key sheet for electronic devices, such a cellular phone, PHS, portable information terminal (PDA or the like), portable audio unit, and remote controller for electric home appliances, and a key unit having the key sheet.

### DESCRIPTION OF REFERENCE NUMERALS

2a to 2f: key unit
4: wiring board
6: metal dome
8: illumination light source (LED)
10: pressing element sheet
12: pressing element
20: key base
22: key top
22A: key top aggregate plate
24: case (body)

1. A key sheet comprising:
a key base made of a transparent or translucent resin;
a plurality of key tops provided on said key base; and
pressing elements or a pressing element sheet having pressing elements provided at a bottom side thereof, provided at a bottom surface of said key base,
wherein said key base is molded, into a sheet form, of a thermoplastic resin which is solid at a room temperature and obtains adhesive force only in a physical change of hot melting and cooling solidification.

2. The key sheet according to claim 1, wherein the thermoplastic resin of which said key base is formed is a polyester, acrylic, polyolefin, polyurethane or polyamide hot melt material.

3. The key sheet according to claim 1, wherein a melting temperature of said key base is equal to or higher than 100° C.

4. A key unit comprising at least:
the key sheet as set forth in claim 1;
a wiring board on which said key sheet is to be mounted;
switching elements which are disposed at positions corresponding to the respective key tops of said key sheet and are switched by operating said key tops on said key base; and
an illumination light source, whereby light emitted from said illumination light source illuminates said key tops.
